(19) United States
(12) Patent Application Publication
(10) Pub. No.: US 2022/0396414 A1
(43) Pub. Date: Dec. 15, 2022

(54) TEXTURE MATERIAL DISPENSING SYSTEM INCLUDING AN ADJUSTABLE OUTLET OPENING

(71) Applicant: DAP Products Inc., Baltimore, MD (US)

(72) Inventors: Louis Vasiliades, Baltimore, MD (US); James Kenney, Baltimore, MD (US); Kenneth Rueschhoff, Fenton, MO (US); Nicholas Lange, Fenton, MO (US)

(21) Appl. No.: 17/806,357

(22) Filed: Jun. 10, 2022

Related U.S. Application Data
(60) Provisional application No. 63/209,105, filed on Jun. 10, 2021.

(51) Int. Cl. B65D 83/28

(52) U.S. Cl. CPC B65D 83/285

(57) ABSTRACT

Described herein is a texture material dispensing system. The system includes a container assembly, an actuator assembly, and an outlet assembly. The container assembly includes a container and a valve assembly. The actuator assembly includes a trigger actuator pivotably attached to an actuator housing. The outlet assembly includes a flexible tube fluidically connected to the trigger actuator and an adjustable outlet opening. The adjustable outlet opening is adjustable between a position that is aligned substantially parallel to a container assembly axis and a position that is aligned substantially non-parallel to a container assembly axis. Also described herein is a method of using the texture material dispensing system for dispensing a texture material onto a target surface.

### CROSS-REFERENCE TO RELATED APPLICATIONS

This application claims priority to U.S. Provisional Application Ser. No. 63/209,105, filed on Jun. 10, 2021, the content of which is hereby incorporated by reference in its entirety.

### FIELD OF DISCLOSURE

The present disclosure is directed to a texture material dispensing system that includes an adjustable outlet opening. The texture material dispensing system may be used for dispensing a texture material onto a target surface.

### BACKGROUND

Liquid spray dispensers can be utilized in a variety of applications. For instance, spray dispensers may utilize aerosol to dispense coatings such as texture material, paint, or household cleaners. Handheld liquid spray dispensers generally utilize aerosol as a propellant to propel liquid through a nozzle, in response to actuation of a valve that results in pressurized liquid being propelled out of an attached spray can. For instance, a trigger or other mechanism may be used to actuate the valve, with liquid in the can being propelled through a nozzle and out of an orifice of the spray dispenser onto a surface.

While useful for a variety of applications, known spray dispensers may suffer from a rigid flow path and a lack of an adjustable orifice. Such known spray dispensers have limited configurability and adjustability. In addition, rigid flow paths have sharp turns that promote clogging. Users of such known spray dispensers may be required to stop the application mid-task to exchange the known spray dispensers for other known spray dispensers or make time-consuming and elaborate adjustments.

In addition, known spray dispensers may be unsuitable for spraying different surfaces, such as surfaces that are orthogonal to one another. Such known spray dispensers are incapable of such spraying and attempts at such spraying may result in harm to the fluidics of the known spray dispensers, particularly for large differences in the angles of the surfaces.

These and other matters have presented challenges to the manufacture and implementation of liquid spray dispensers for a variety of applications. Further, these challenges are particularly relevant to texture material dispensers, which contain and dispense viscous and hardenable compositions. For at least these reasons, there is a need in the industry for a readily adjustable texture material dispensing system.

Described herein is a readily adjustable texture material dispensing system. The texture material dispensing system includes an adjustable outlet that may include an adjustable orifice to provide an adjustable and desired amount of texture material in a variety of texture patterns.

### BRIEF DESCRIPTION OF THE DISCLOSURE

In one embodiment of the present disclosure, provided herein is a texture material dispensing system including a container assembly, an actuator assembly, and an outlet assembly. The container assembly includes a container and a valve assembly. The actuator assembly includes a trigger actuator pivotably attached to an actuator housing. The outlet assembly includes a flexible tube fluidically connected to the trigger actuator and an adjustable outlet opening. The adjustable outlet opening is adjustable between a position that is aligned substantially parallel to a container assembly axis and a position that is aligned substantially non-parallel to a container assembly axis.

In another embodiment of the present disclosure, provided herein is a method of using a texture material dispensing system including a container assembly, an actuator assembly, and an outlet assembly. The container assembly includes a container and a valve assembly. The actuator assembly includes a trigger actuator pivotably attached to an actuator housing. The outlet assembly includes a flexible tube fluidically connected to the trigger actuator and an adjustable outlet opening. The adjustable outlet opening is adjustable between a position that is aligned substantially parallel to a container assembly axis and a position that is aligned substantially non-parallel to a container assembly axis. The method includes using the texture material dispensing system for dispensing a texture material onto a target surface.

### BRIEF DESCRIPTION OF THE DRAWINGS

The following figures are examples of texture material dispensing systems in accordance with the present disclosure and are not to be construed as limiting.

Various example embodiments may be more completely understood in consideration of the following detailed description and in connection with the accompanying drawings, in which:

FIG. 1A shows a front view of a first embodiment of a texture material dispensing system in accordance with the present disclosure.

FIG. 1B shows a perspective view of the texture material dispensing system shown in FIG. 1A in accordance with the present disclosure.

FIG. 2A shows a perspective view of a second embodiment of a texture material dispensing system in accordance with the present disclosure.

FIG. 2B shows a cross-sectional view of the texture dispensing material dispensing system shown in FIG. 2A in accordance with the present disclosure.

FIG. 3A shows a perspective view of a third embodiment of a texture material dispensing system in accordance with the present disclosure.

FIG. 3B shows a cross-sectional view of the texture material dispensing system shown in FIG. 3A in accordance with the present disclosure.

FIG. 4 shows a perspective view of a container assembly used by a texture material dispensing system in accordance with the present disclosure.

FIG. 5A shows a first full view of a fourth embodiment of a texture material dispensing system in accordance with the present disclosure.

FIG. 5B shows a second full view of the texture material dispensing system shown in FIG. 5A in accordance with the present disclosure.

FIG. 5C shows a first cross-sectional view of a housing of the texture material dispensing system shown in FIG. 5A in accordance with the present disclosure.

FIG. 5D shows a second cross-sectional view of the texture material dispensing system shown in FIG. 5A in accordance with the present disclosure.

FIG. 5E shows a third cross-sectional view of the texture material dispensing system shown in FIG. 5A in accordance with the present disclosure.

FIG. 5F shows a perspective view of the texture material dispensing system shown in FIG. 5A, without the outlet assembly, in accordance with the present disclosure.

FIG. 5G shows a first full view of an adjustable outlet assembly of the texture material dispensing system shown in FIG. 5A in accordance with the present disclosure.

FIG. 5H shows a second full view of an adjustable outlet assembly of the texture material dispensing system shown in FIG. 5A in accordance with the present disclosure.

FIG. 5I shows a cross-sectional view of an adjustable outlet assembly of the texture material dispensing system shown in FIG. 5A in accordance with the present disclosure.

FIG. 5J shows a third full view of an adjustable outlet assembly of the texture material dispensing system shown in FIG. 8A in accordance with the present disclosure.

FIG. 5K shows a fourth full view of an adjustable outlet assembly of the texture material dispensing system shown in FIG. 5A in accordance with the present disclosure.

FIG. 6A shows a first full view of a fifth embodiment of a texture material dispensing system in accordance with the present disclosure.

FIG. 6B shows a second full view of the texture material dispensing system shown in FIG. 6A in accordance with the present disclosure.

FIG. 6C shows a first cross-sectional view of the texture material dispensing system shown in FIG. 6A in accordance with the present disclosure.

FIG. 6D shows a second cross-sectional view of the texture material dispensing system shown in FIG. 6A in accordance with the present disclosure.

FIG. 6E shows a third cross-sectional view of the texture material dispensing system shown in FIG. 6A in accordance with the present disclosure.

FIG. 6F shows a perspective view of the texture material dispensing system shown in FIG. 6A, without the outlet assembly, in accordance with the present disclosure.

FIG. 6G shows a first full view of an adjustable outlet assembly of the texture material dispensing system shown in FIG. 6A in accordance with the present disclosure.

FIG. 6H shows a second full view of an adjustable outlet assembly of the texture material dispensing system shown in FIG. 6A in accordance with the present disclosure.

FIG. 6I shows a third full view of an adjustable outlet assembly of the texture material dispensing system shown in FIG. 6A in accordance with the present disclosure.

FIG. 7A shows a first full view of a sixth embodiment of a texture material dispensing system in accordance with the present disclosure.

FIG. 7B shows a second full view of the texture material dispensing system shown in FIG. 7A in accordance with the present disclosure.

FIG. 7C shows a first cross-sectional view of the texture material dispensing system shown in FIG. 7A in accordance with the present disclosure.

FIG. 7D shows a second cross-sectional view of the texture material dispensing system shown in FIG. 7A in accordance with the present disclosure.

FIG. 7E shows a third cross-sectional view of the texture material dispensing system shown in FIG. 7A in accordance with the present disclosure.

FIG. 7F shows a perspective view of the texture material dispensing system shown in FIG. 7A, without the outlet assembly, in accordance with the present disclosure.

FIG. 7G shows a first full view of an adjustable outlet assembly of the texture material dispensing system shown in FIG. 7A in accordance with the present disclosure.

FIG. 7H shows a second full view of an adjustable outlet assembly of the texture material dispensing system shown in FIG. 7A in accordance with the present disclosure.

FIG. 7I shows a third full view of an adjustable outlet assembly of the texture material dispensing system shown in FIG. 7A in accordance with the present disclosure.

### DETAILED DESCRIPTION

While various embodiments discussed herein are amenable to modifications and alternative forms, aspects thereof have been shown by way of example in the drawings and will be described in detail. It should be understood, however, that the intention is not to limit the invention of the particular embodiments described. On the contrary, the intention is to cover all modifications, equivalents, and alternatives falling within the scope of the disclosure including aspects defined in the claims.

Described herein is a texture material dispensing system. The texture material dispensing system may be used for dispensing a texture material onto a target surface.

Particularly described herein is a texture material dispensing system including a container assembly, an actuator assembly, and an outlet assembly. The container assembly includes a container and a valve assembly. The actuator assembly includes a trigger actuator pivotably attached to an actuator housing. The outlet assembly includes a flexible tube fluidically connected to the trigger actuator and an adjustable outlet opening optionally including an adjustable orifice to control a flow rate and/or pattern of the dispensed texture material. The adjustable outlet opening is adjustable between a position that is aligned substantially parallel to a container assembly axis and a position that is aligned substantially non-parallel to a container assembly axis.

In many embodiments, the dispenser may be in the form of any suitable dispenser known in the art. In some embodiments, the dispenser is in a form selected from the group consisting of cans, canisters, bottles, containers, applicators, mechanical applicators, electric applicators, and pneumatic applicators. In some embodiments, the dispenser is a canister.

The outlet assembly may be connected to the actuator assembly through attachment mechanisms known in the art. Example attachment mechanisms include physical couplings, adhesives, overmolding, snap connections, and combinations thereof. In some embodiments, the outlet assembly snaps onto the actuator assembly. In some embodiments, the outlet assembly snaps onto the actuator assembly via a plurality of snap features. In some embodiments, the outlet assembly snaps onto the actuator assembly via a plurality of snap features and locating posts.

Similarly, the actuator assembly may be connected to the container assembly through attachment mechanisms known in the art. Example attachment mechanisms include physical couplings, adhesives, overmolding, snap connections, and combinations thereof. In some embodiments, the actuator assembly snaps onto the container assembly. In some embodiments, the actuator assembly snaps onto the container assembly via a plurality of snap features. In some embodiments, the actuator assembly snaps onto the container assembly via a plurality of snap features and locating posts.

In general, the trigger actuator controls actuation of the dispenser. In some embodiments, depression of the trigger actuator causes the trigger actuator to engage the valve assembly to alter the valve assembly from a closed configuration to an open configuration. When the dispenser is in a closed configuration, no texture material is able to flow through the dispenser. When the dispenser is in an open configuration, texture material is able to flow through the dispenser. In some embodiments, the trigger actuator comprises a spring to assist the trigger actuator in returning to a non-use position after depression of the trigger actuator.

The adjustable outlet opening allows a user to use the dispenser for a variety of purposes while making real-time adjustments as required by an application. For example, this allows a user to easily spray a texture material onto a surface at any angle.

In many embodiments, the adjustable outlet opening is adjusted through an adjustment means selected from the group of pivoting, sliding, rotating, and combinations thereof. In many embodiments, the adjustable outlet opening is an adjustable outlet opening selected from the group consisting of a pivotable outlet opening, a rotatable outlet opening, a slidable outlet opening, and combinations thereof.

In some embodiments, the adjustable outlet opening is a pivotable outlet opening. In some embodiments, the pivotable outlet opening pivots around an outlet pivot within the actuator housing. In some embodiments, the pivotable outlet opening pivots around an outlet pivot outside the actuator housing. In some embodiments, the outlet pivot comprises a detent portion to hold the pivotable outlet opening at a desired angle. In some embodiments, the detent portion comprises at least one location that clicks when the pivotable outlet opening is pivoted into the at least one location. In some embodiments, a detent portion between the outlet and cap allows for at least one, at least two, or at least three discrete locations that click. This allows a user to find a desired angle setting and provides uniformity of texture material delivery.

In many embodiments, the pivotable outlet opening is fully pivotable relative to the container assembly axis. In this regard, fully pivotable is understood to mean the outlet opening can be pivoted between positions having opposite angles that are each orthogonal to the container assembly axis.

In some embodiments, the pivotable outlet opening is fully pivotable along one axis. In some embodiments, the pivotable outlet opening is fully pivotable along two axes. In some embodiments, the pivotable outlet opening is fully pivotable along three axes. In some embodiments, the pivotable outlet opening is partially pivotable along one axis. In some embodiments, the pivotable outlet opening is partially pivotable along two axes. In this regard, partially pivotable is understood to mean that the pivoting of the outlet opening is restricted such that full pivotability is not present. In some embodiments, the pivotable outlet opening is pivotable along at least one axis between an angle of 90° and 270° relative to the container assembly axis.

In some embodiments, the pivotable outlet opening is pivotable along at least one axis between an angle of 90° and 265° relative to the container assembly axis. In some embodiments, the pivotable outlet opening is pivotable along at least one axis between an angle of 90° and 260° relative to the container assembly axis. In some embodiments, the pivotable outlet opening is pivotable along at least one axis between an angle of 90° and 255° relative to the container assembly axis. In some embodiments, the pivotable outlet opening is pivotable along at least one axis between an angle of 90° and 250° relative to the container assembly axis. In some embodiments, the pivotable outlet opening is pivotable along at least one axis between an angle of 90° and 245° relative to the container assembly axis. In some embodiments, the pivotable outlet opening is pivotable along at least one axis between an angle of 90° and 240° relative to the container assembly axis. In some embodiments, the pivotable outlet opening is pivotable along at least one axis between an angle of 90° and 235° relative to the container assembly axis. In some embodiments, the pivotable outlet opening is pivotable along at least one axis between an angle of 90° and 230° relative to the container assembly axis. In some embodiments, the pivotable outlet opening is pivotable along at least one axis between an angle of 90° and 225° relative to the container assembly axis. In some embodiments, the pivotable outlet opening is pivotable along at least one axis between an angle of 90° and 220° relative to the container assembly axis. In some embodiments, the pivotable outlet opening is pivotable along at least one axis between an angle of 90° and 215° relative to the container assembly axis. In some embodiments, the pivotable outlet opening is pivotable along at least one axis between an angle of 90° and 210° relative to the container assembly axis. In some embodiments, the pivotable outlet opening is pivotable along at least one axis between an angle of 90° and 205° relative to the container assembly axis. In some embodiments, the pivotable outlet opening is pivotable along at least one axis between an angle of 90° and 200° relative to the container assembly axis. In some embodiments, the pivotable outlet opening is pivotable along at least one axis between an angle of 90° and 195° relative to the container assembly axis. In some embodiments, the pivotable outlet opening is pivotable along at least one axis between an angle of 90° and 190° relative to the container assembly axis. In some embodiments, the pivotable outlet opening is pivotable along at least one axis between an angle of 90° and 185° relative to the container assembly axis.

In many embodiments, the pivotable outlet opening is pivotable between a position that is aligned substantially parallel to a container assembly axis and a position that is aligned substantially non-parallel to a container assembly axis. In some embodiments, the pivotable outlet opening is pivotable along at least one axis between an angle of 90° and 180° relative to the container assembly axis.

In some embodiments, the pivotable outlet opening is pivotable along at least one axis between an angle of 90° and 175° relative to the container assembly axis. In some embodiments, the pivotable outlet opening is pivotable along at least one axis between an angle of 90° and 170° relative to the container assembly axis. In some embodiments, the pivotable outlet opening is pivotable along at least one axis between an angle of 90° and 165° relative to the container assembly axis. In some embodiments, the pivotable outlet opening is pivotable along at least one axis between an angle of 90° and 160° relative to the container assembly axis. In some embodiments, the pivotable outlet opening is pivotable along at least one axis between an angle of 90° and 155° relative to the container assembly axis. In some embodiments, the pivotable outlet opening is pivotable along at least one axis between an angle of 90° and 150° relative to the container assembly axis. In some embodiments, the pivotable outlet opening is pivotable along at least one axis between an angle of 90° and 145° relative to the container assembly axis. In some embodiments, the pivotable outlet opening is pivotable along at least one axis between an angle of 90° and 140° relative to the container assembly axis. In some embodiments, the pivotable outlet opening is pivotable along at least one axis between an angle of 90° and 135° relative to the container assembly axis. In some embodiments, the pivotable outlet opening is pivotable along at least one axis between an angle of 90° and 130° relative to the container assembly axis. In some embodiments, the pivotable outlet opening is pivotable along at least one axis between an angle of 90° and 125° relative to the container assembly axis. In some embodiments, the pivotable outlet opening is pivotable along at least one axis between an angle of 90° and 120° relative to the container assembly axis. In some embodiments, the pivotable outlet opening is pivotable along at least one axis between an angle of 90° and 115° relative to the container assembly axis. In some embodiments, the pivotable outlet opening is pivotable along at least one axis between an angle of 90° and 110° relative to the container assembly axis. In some embodiments, the pivotable outlet opening is pivotable along at least one axis between an angle of 90° and 105° relative to the container assembly axis. In some embodiments, the pivotable outlet opening is pivotable along at least one axis between an angle of 90° and 100° relative to the container assembly axis. In some embodiments, the pivotable outlet opening is pivotable along at least one axis between an angle of 90° and 95° relative to the container assembly axis.

In many embodiments, the adjustable outlet opening comprises a flexible tube. Any suitable flexible tube known in the art may be used. In some embodiments, the flexible tube is composed of a plastic material. The flexible tube can be made of known flexible material, including a material selected from fluoropolymers, polyolefins, silicones, rubbers, ethylene propylene diene terpolymer (EPDM) rubber, perfluoroalkoxy alkane (PFA), polytetrafluoroethylene (PTFE), vinyl polymers, polyvinyl chloride (PVC), polyethylene (PE), polypropylene (PP), and combinations thereof. The flexible tube maintains fluidic connection between the actuator and the adjustable outlet opening for all adjustment and/or pivot angles. In some embodiments, the flexible tubing delivers texture material in an anti-clogging manner. In these embodiments, the flexible tubing provides a continuous flow path lacking sharp turns inherent to molded designs.

In many embodiments, the container assembly comprises a container. In some embodiments, the container stores a texture material and a propellant material. The texture material and propellant material may be present separately or in a mixture. In some embodiments, the container stores a composition comprising a texture material and a propellant material.

Generally, the texture material dispensing system is configured to deliver suitable texture materials known in the art. In some embodiments, the texture materials comprise a water-based texture material, a solvent-based texture material, or combinations thereof. In many embodiments, the texture material dispensing system is configured for dispensing an aerosol comprising a texture material. In some embodiments, the aerosol comprises a texture material and a propellant.

Generally, any suitable texture material known in the art may be used in the texture dispensing system. Suitable texture materials known in the art are capable of delivering a variety of textures. In some embodiments, the texture material comprises a texture selected from the group consisting of a knockdown texture, an orange peel texture, a popcorn texture, and combinations thereof.

Generally, any suitable propellant known in the art may be used in the texture dispensing system. Suitable propellants known in the art are capable of delivering a variety of materials, including texture materials. In some embodiments, the propellant comprises a propellant selected from the group consisting of hydrocarbon propellants, A-85 propellant, ether propellants, dimethyl ether (DME) propellant, chlorofluorocarbon (CFC) propellants, hydrofluoroolefin (HFO) propellants, hydrofluorocarbons (HFC), and combinations thereof.

Generally, the texture material dispensing system is configured to deliver suitable texture materials to surfaces known in the art. In many embodiments, the texture material dispensing system is configured for dispensing a texture material onto a target surface. In some embodiments, the target surface is selected from the group consisting of a horizontal surface, a vertical surface, an angled surface, and combinations thereof. In some embodiments, the target surface is selected from the group consisting of a ceiling, a wall, an interior wall, an exterior wall, a construction surface, a floor, and combinations thereof. When the target surface is a floor, the texture materials provide skid resistance.

In some embodiments, the surface is smooth. In some embodiments, the surface is rough. In some embodiments, the surface is pre-textured. In some embodiments, the surface is a repaired surface. In some embodiments, the surface is a repaired surface, wherein the repaired surface is a smooth surface that is surrounded by a textured surface. In some embodiments, the surface has a texture selected from the group consisting of a knockdown texture, an orange peel texture, a popcorn texture, and combinations thereof.

Generally, the texture material dispensing system includes an orifice that is an adjustable orifice or non-adjustable orifice. In many embodiments, the texture material dispensing system includes an adjustable orifice to control a flow rate and/or pattern of texture material. In many embodiments, the adjustable orifice comprises a threaded outlet, a screw cap, a deformable outlet tube, and at least one deformable finger. In some embodiments, the flow rate of dispensed texture material is proportional to the tightness of the screw cap on the threaded outlet. When the screw cap is tightened, the deformable finger is deformed and restricts the deformable outlet tube within the adjustable orifice. In some embodiments, a cross-sectional area of the deformable outlet tube within the adjustable orifice is proportional to the tightness of the screw cap on the threaded outlet.

In many embodiments, the orifice is adjusted through an adjustment means selected from the group of pivoting, sliding, rotating, and combinations thereof. In many embodiments, the orifice is an adjustable orifice selected from the group consisting of a pivotable orifice, a rotating orifice, a slidable orifice, and combinations thereof.

In many embodiments, the adjustable orifice comprises a backstop to prevent overtightening of the screw cap. The backstop prevents damage to the adjustable orifice. The backstop also prevents a user from closing the outlet off completely and prevents a user from passing the desired texture for a surface.

In many embodiments, the adjustable orifice comprises a stop to prevent removal of the screw cap from the adjustable orifice. In some embodiments, the stop comprises an indicator of the flow rate of the texture material. The indicator may be present as an indicator arrow, line, dot, or other marker. The indicator may act as a spring, lifting over a one-way cam clutch feature on the cap and/or over a shoulder. Once the spring lifts over the cam clutch and/or shoulder in this way, it cannot lift back over, thereby preventing the cap from being completely removed from the outlet assembly. The indicator can be labeled to describe the desired flow output, such as “fine”, “medium”, or “heavy”. The indicator prevents a user from passing the desired texture for a surface.

Described herein is a method of using a texture material dispensing system including a container assembly, an actuator assembly, and an outlet assembly. The container assembly includes a container and a valve assembly. The actuator assembly includes a trigger actuator pivotably attached to an actuator housing. The outlet assembly includes a flexible tube fluidically connected to the trigger actuator and an adjustable outlet opening optionally including an adjustable orifice to control a flow rate and/or pattern of the dispensed texture material. The adjustable outlet opening is adjustable between a position that is aligned substantially parallel to a container assembly axis and a position that is aligned substantially non-parallel to a container assembly axis. The method comprises using the texture material dispensing system for dispensing a texture material onto a target surface.

Aspects of the present disclosure are applicable to a variety of different types of assemblies, systems and methods involving dispensing of texture materials via aerosols from pressurized containers. Various embodiments are directed to a texture material dispensing system having an adjustable outlet which moves to allow spraying of a spray texture material onto multiple surfaces (horizontal, vertical, or any angle between) while maintaining the can in an upright position to create an ergonomic applicator. Such a system is readily adaptable to a variety of applications, uses, and environments. In addition, an upright can promotes dispensing of a proper mix of texture material and propellant, so that pressure does not drop prematurely.

Other embodiments are directed to a texture material dispensing system having an adjustable outlet which moves to allow spraying of a spray texture material onto multiple surfaces (horizontal, vertical, or any angle between) while maintaining the can in an upside-down position. In these embodiments, the texture material dispensing system does not include a dip tube. Such a system is readily adaptable to a variety of applications, uses, and environments. In addition, an upside-down can promotes dispensing of a proper mix of texture material and propellant, so that the potential for clogging is reduced. Moreover, an inverted arrangement without a dip tube is particularly useful for high viscosity materials because it avoids head losses in a dip tube.

In some particular embodiments, an actuator assembly for a texture material dispenser in accordance with the present disclosure includes an actuator housing having a lower housing and an upper housing. The lower and upper housing are fastened together using plastic hook and groove features. The lower housing has a snap feature which allows for a trigger actuator to be rotatably coupled to the housing. There are two posts extending outward from the trigger actuator, which allows the trigger actuator to be snapped into the housing and rotate about the housing. The trigger actuator includes an integral spring that functions to move the trigger actuator back to its original position after being rotated in the housing during spraying. The trigger actuator further includes a lock that prevents it from rotating in an incorrect direction (i.e. out of the housing). The trigger actuator may also include a lock, such as a break-away tab, that prevents the trigger from being depressed unintentionally. The trigger actuator, when depressed, mates with a valve of a dispenser (e.g. can) of aerosol spray texture to provide a passageway from the valve of the dispenser to a flexible tubing. In other words, when the trigger actuator is rotated, the valve on the dispenser is depressed, thereby allowing material to flow into the actuator, then into the flexible tubing, and finally out of an outlet assembly.

In some particular embodiments, an actuator assembly for a texture material dispenser in accordance with the present disclosure includes a monolithic actuator housing. The monolithic actuator housing may be a solitary molded piece. The housing has a snap feature which allows for a trigger actuator to be rotatably coupled to the housing. There are two posts extending outward from the trigger actuator, which allows the trigger actuator to be snapped into the housing and rotate about the housing. The trigger actuator includes an integral spring that functions to move the trigger actuator back to its original position after being rotated in the housing during spraying. The housing includes a lock that prevents the trigger actuator from rotating in an incorrect direction (i.e. out of the housing). The housing may also include a lock, such as a tab, a break-away tab, or a bend tab, that prevents the trigger from being depressed unintentionally. The lock may be adjustable and/or moveable by a user and comprise a user interface. The lock may prevent movement of both the trigger and adjustable outlet assembly via posts extending off both the trigger and the adjustable outlet assembly. Preventing movement of the adjustable outlet assembly is particularly beneficial when the texture material dispenser is in production. When the lock is a bend tab, it is reusable and may be used to store the texture dispensing system after use. The trigger actuator, when depressed, mates with a valve of a dispenser (e.g. can) of aerosol spray texture to provide a passageway from the valve of the dispenser to a flexible tubing. In other words, when the trigger actuator is rotated, the valve on the dispenser is depressed, thereby allowing material to flow into the actuator, then into the flexible tubing, and finally out of an outlet assembly.

In particular embodiments, a flexible tubing runs from a trigger actuator and connects directly to an outlet assembly. The flexible tubing allows for the outlet assembly to rotate so it may spray onto multiple surfaces. The flexible tubing also provides a smooth fluid flow path. The lack of sharp directional changes minimizes material buildup and clogs. There are two posts extending outward from the outlet assembly, which snap directly into a top housing or monolithic housing of an actuator assembly. The outlet assembly may rotate in the top housing or monolithic housing, thereby providing a range of angles for spraying onto multiple surfaces. A mechanical detent is provided between the outlet assembly and top housing or monolithic housing, thereby providing means for discrete positioning of the outlet assembly while rotating. In an alternative embodiment, the outlet assembly may be assembled to the top housing or monolithic housing through a means of a slidable interface.

In particular embodiments, a cap is attached to an outlet assembly having deformable fingers and an orifice via threaded coupling. Adjusting the cap along the threads allows for size adjustment of the orifice. When the cap is threaded clockwise, it interferes with the deformable fingers. The deformable fingers squeeze a flexible tube, narrowing the orifice size. Changing the size of the orifice directly changes the size of an aerosol spray texture as it flows out of the orifice onto a surface. A mechanical detent is provided between the outlet assembly and the cap, allowing for discrete positioning of the cap such that a user may return to a desired texture size setting easily for a chosen application. Multiple discrete positions of the cap may be chosen freely by the user. An indicator arrow provided on the outlet assembly helps identify which discrete texture size is selected and serves as a backstop for the cap to prevent the cap from being unthreaded from the outlet assembly. The indicator arrow acts as a spring, lifting over a one-way cam clutch feature on the cap. Once the spring lifts over the cam clutch, it cannot lift back over, thereby preventing the cap from being completely removed from the outlet assembly.

In particular embodiments, an outlet switch is attached to the outlet assembly that moves parallel to the outlet assembly. The outlet switch includes a taper that when pressed against the deformable or flexible fingers of the actuator, causes the fingers to collapse and pinch the tube inside the actuator which changes the outlet size. In some embodiments, the outlet switch is a slidable attachment and operates using a detent mechanism between the outlet switch and the actuator housing to keep the switch in a single position for a specific setting. In other embodiments, the outlet switch may move parallel to the outlet assembly and have a series of switch teeth. The switch teeth mesh with cap teeth on the cap surrounding the actuator. When the outlet switch is moved, meshing of cap teeth and switch teeth force the cap, which is threaded onto the actuator, to rotate. The outlet switch in this embodiment is a rotatable attachment. The cap is threaded onto the actuator via a taper and when the taper presses against the flexible fingers of the actuator, the fingers collapse and pinch the tube inside the actuator to change the outlet size.

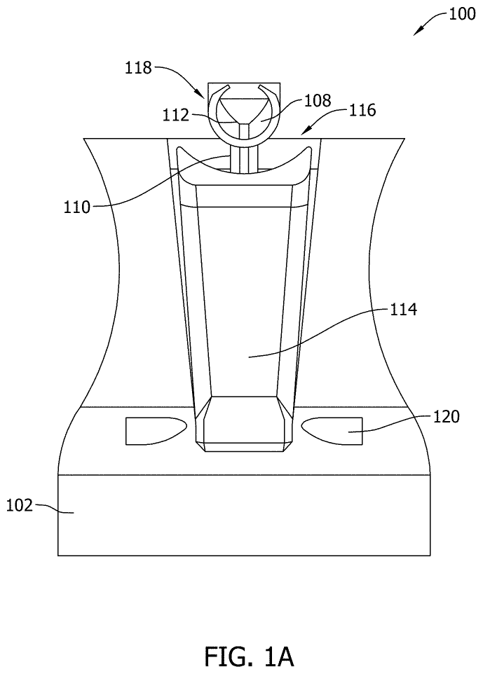

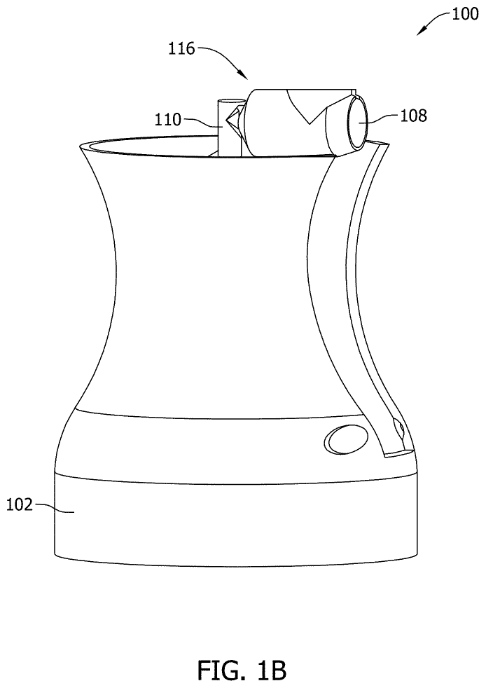

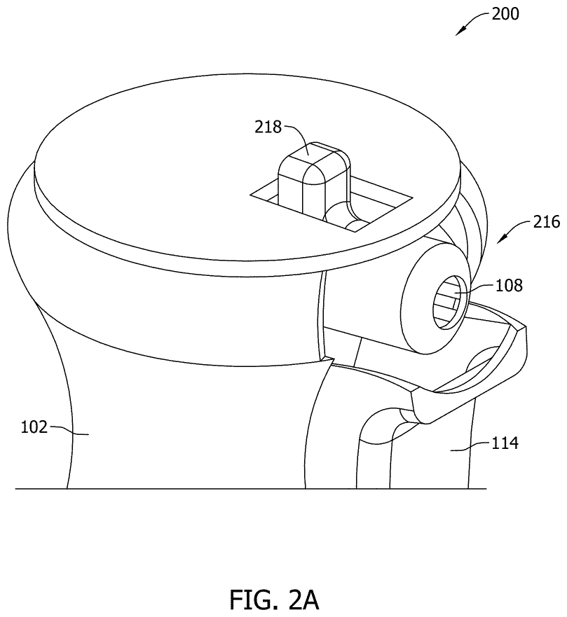

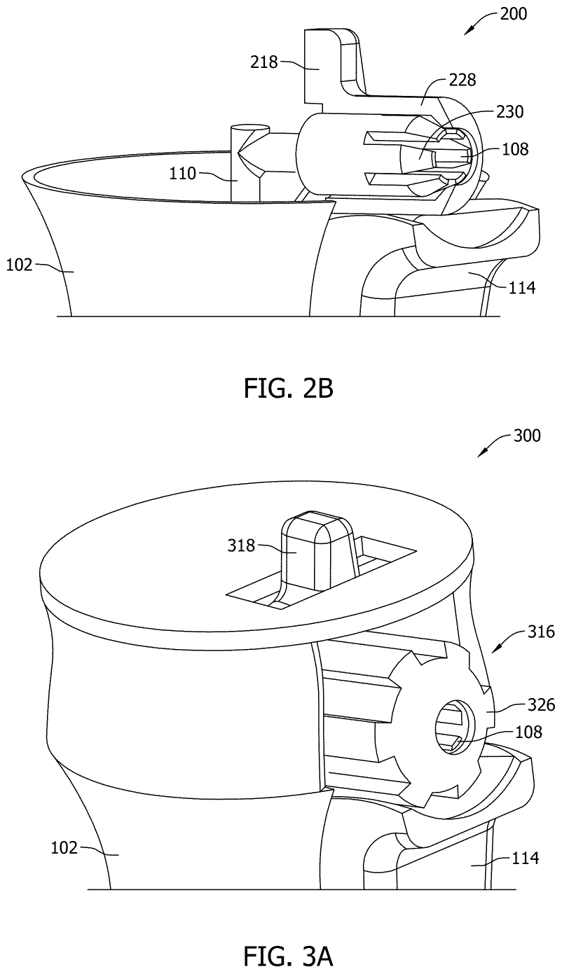

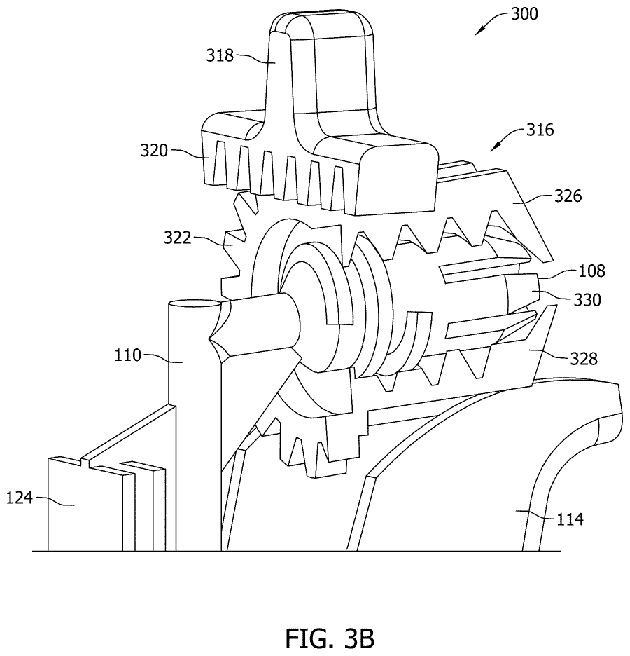

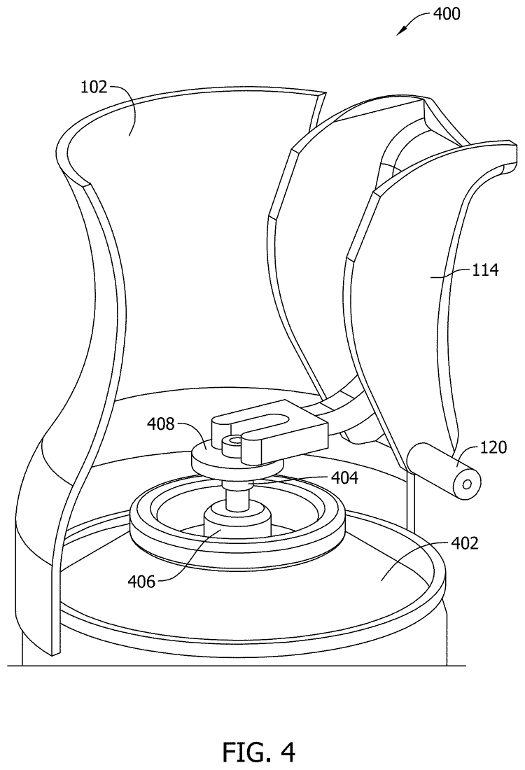

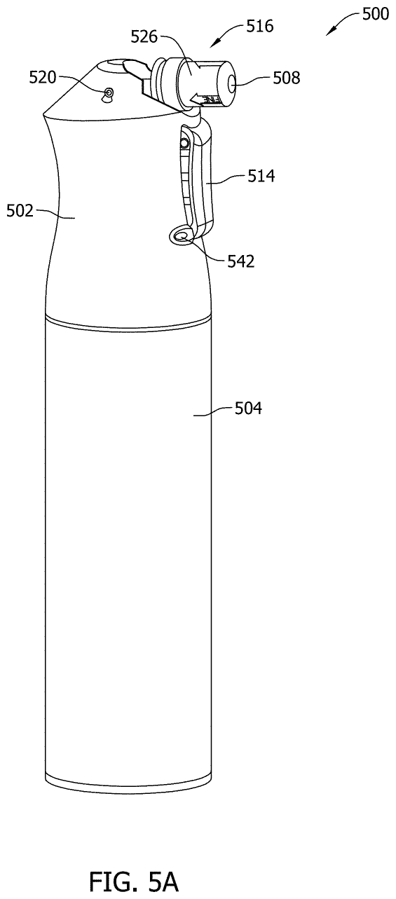

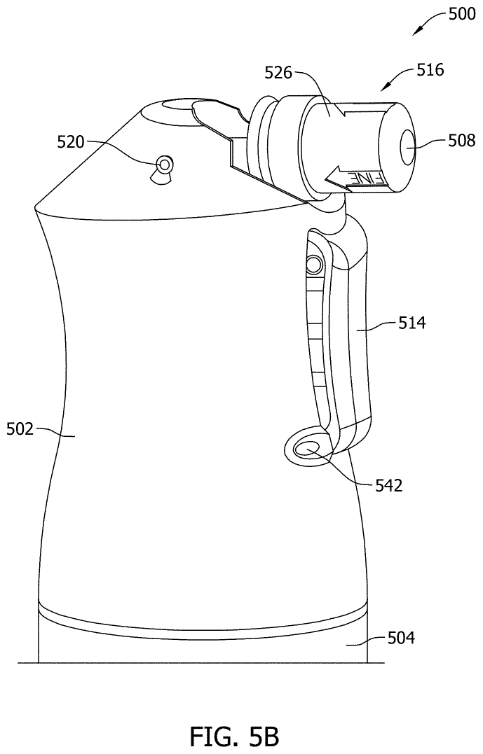

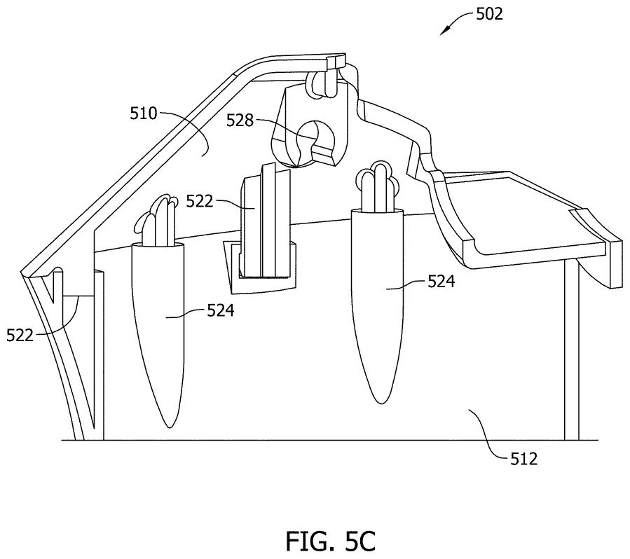

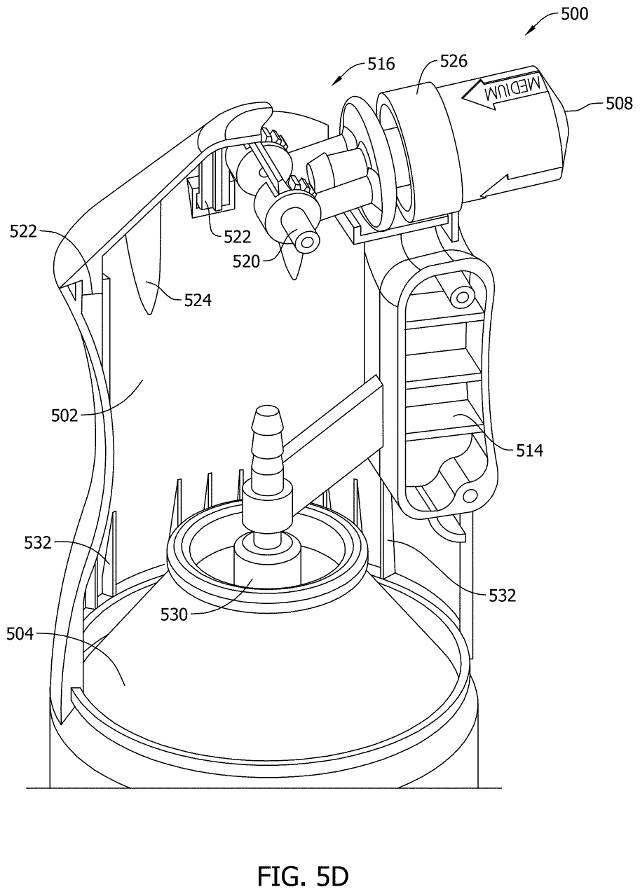

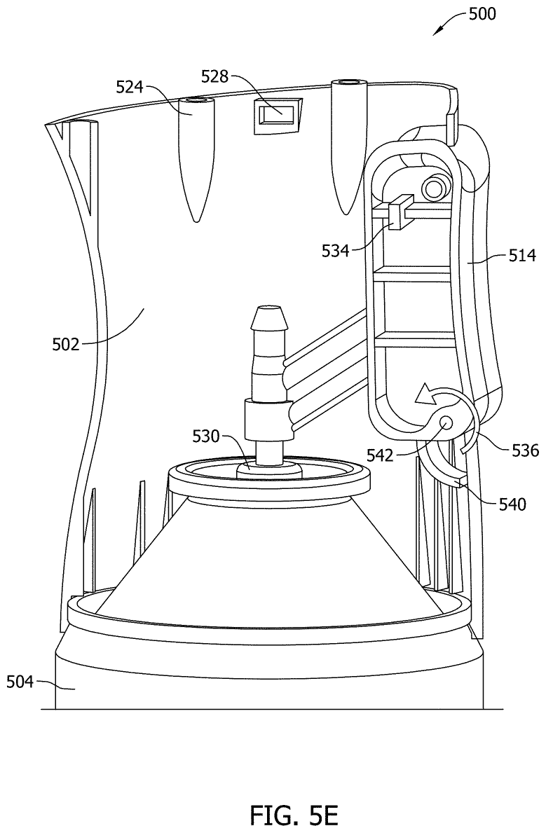

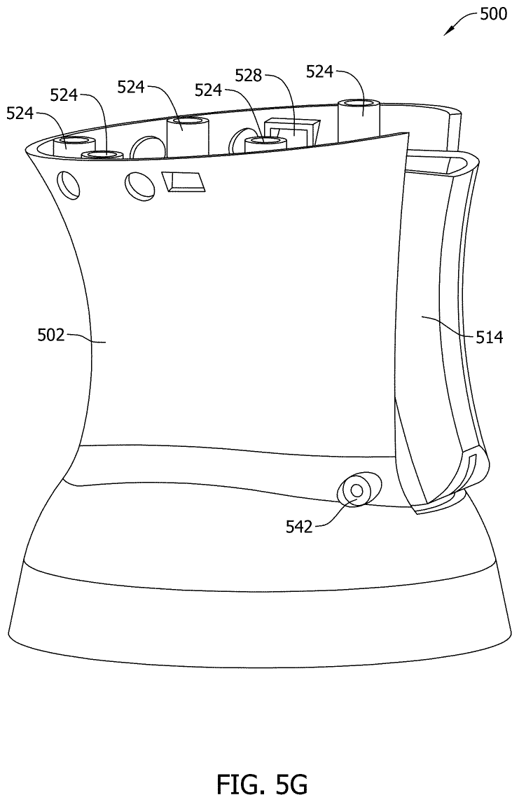

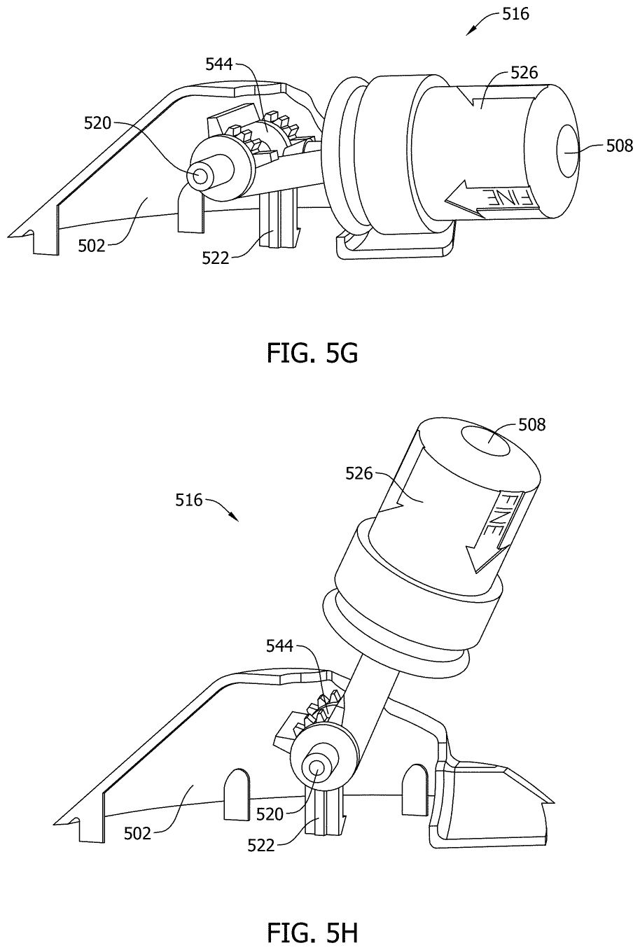

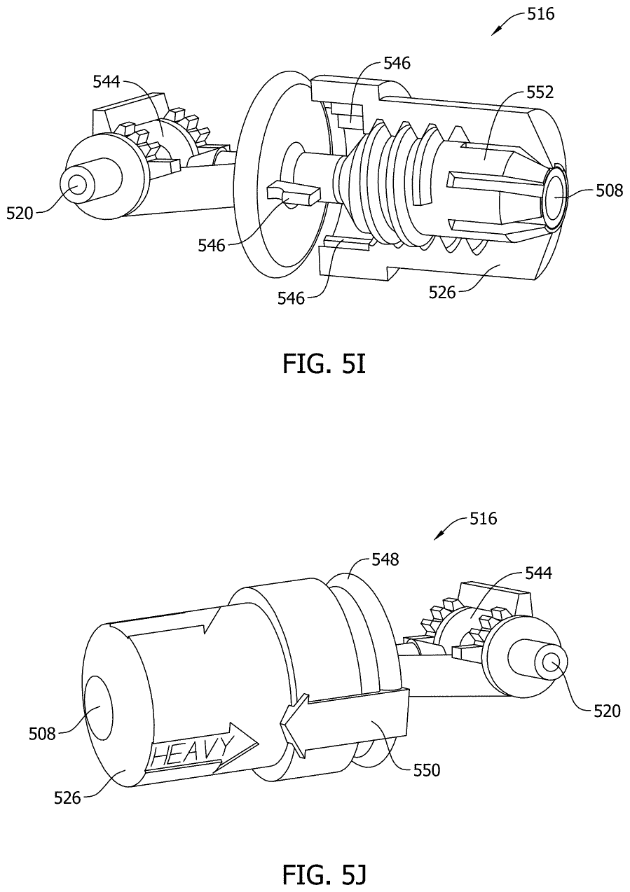

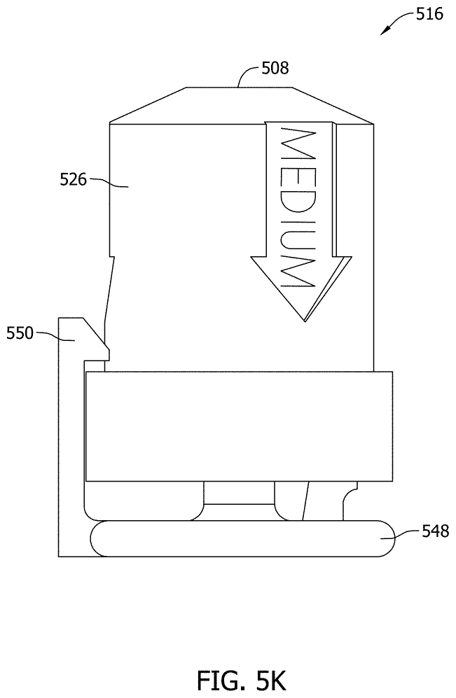

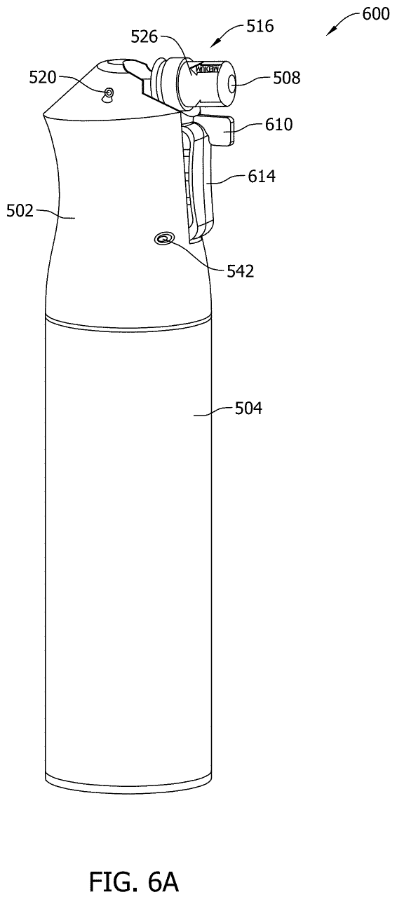

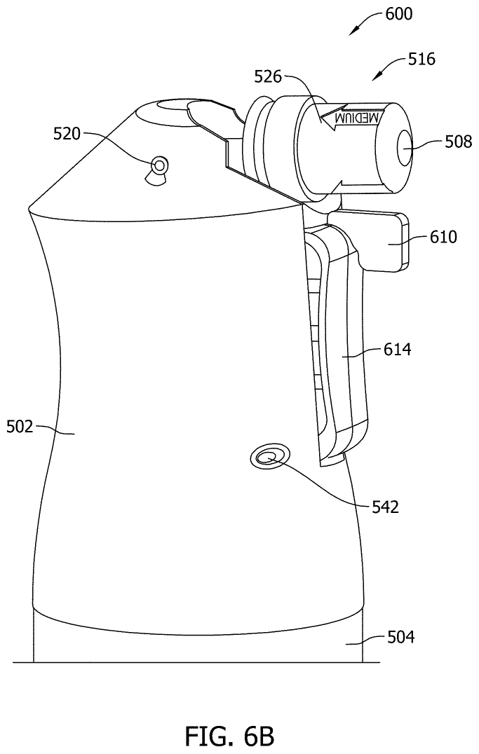

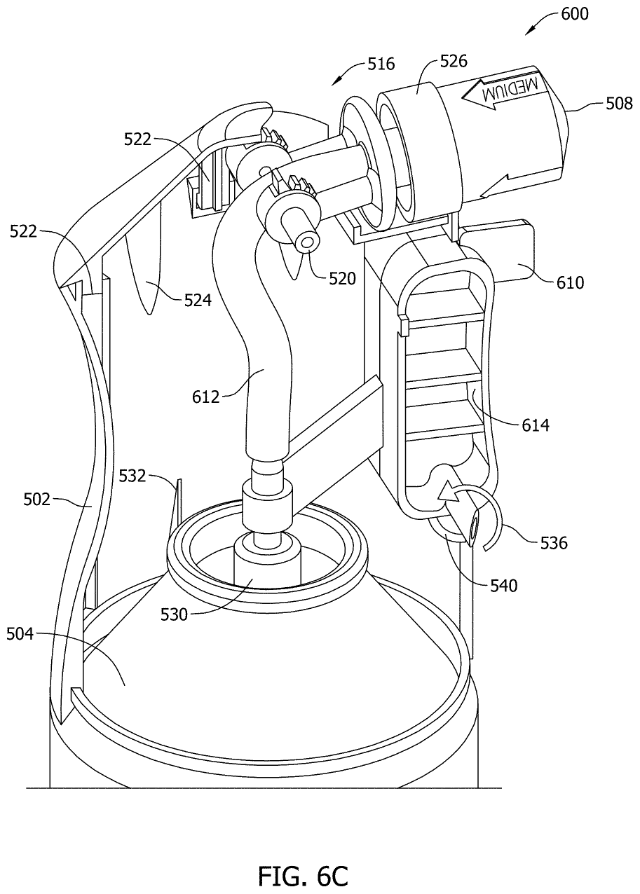

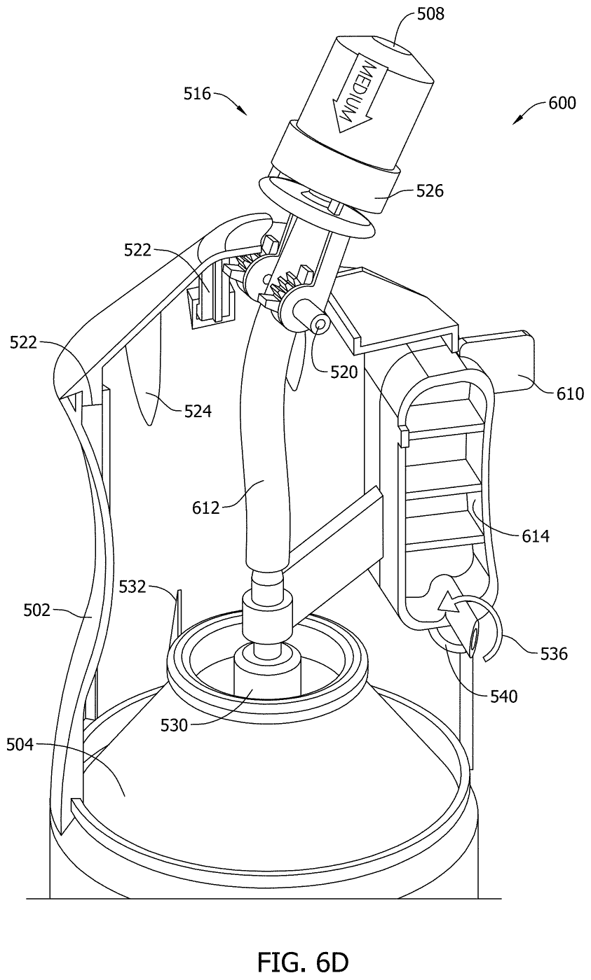

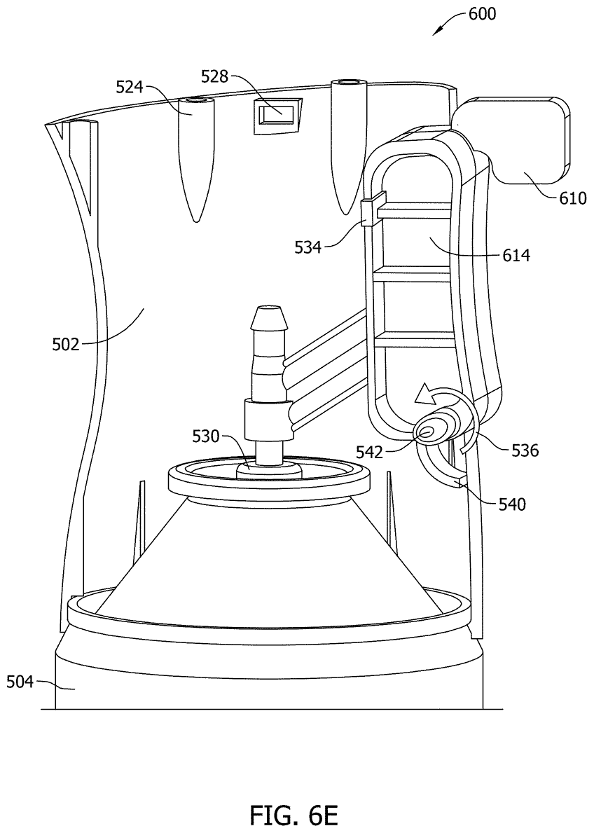

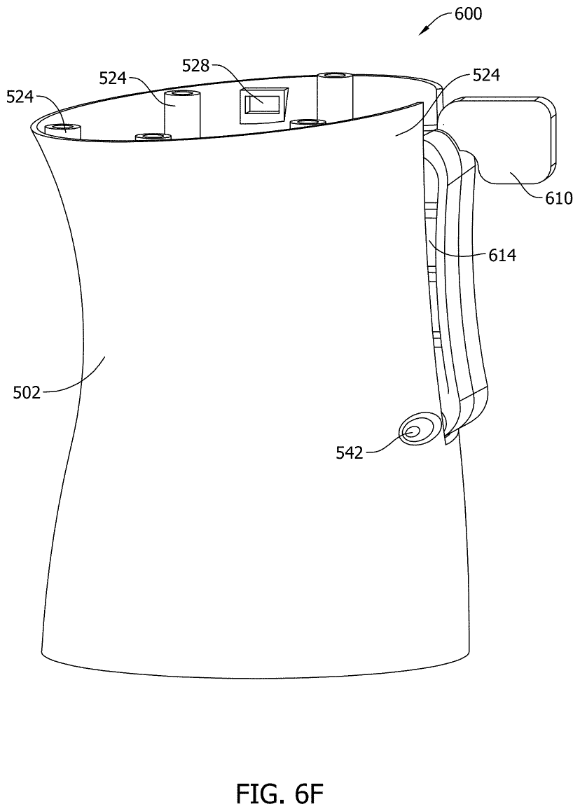

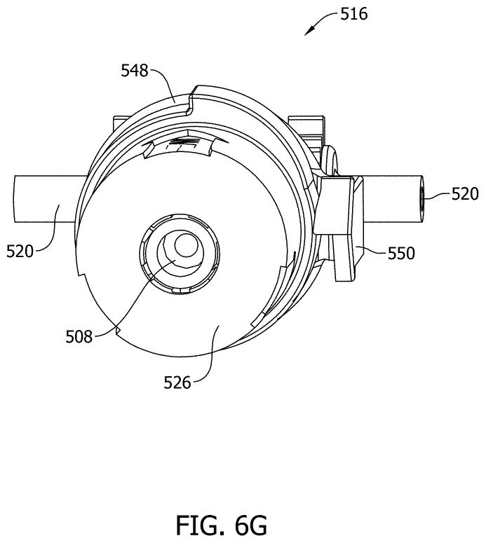

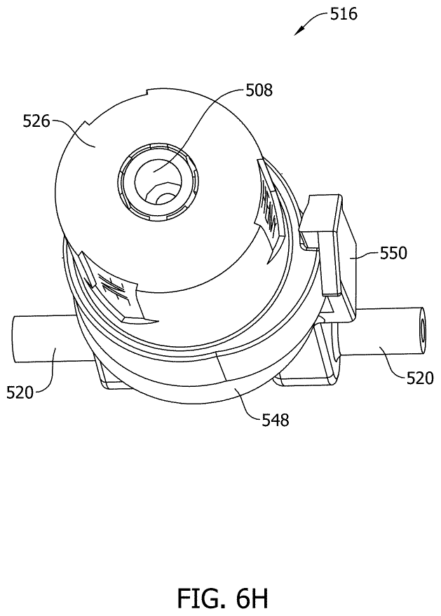

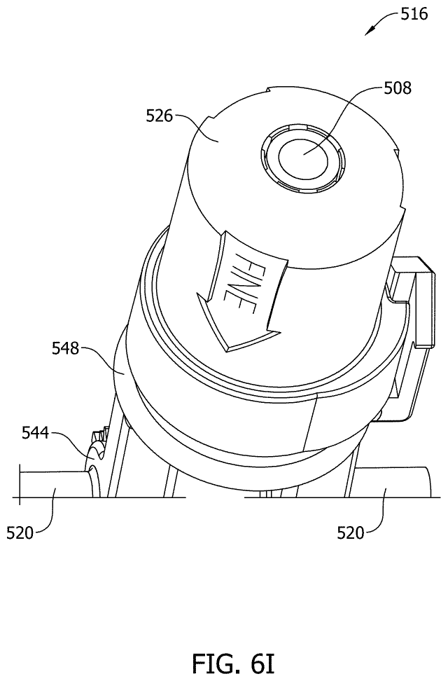

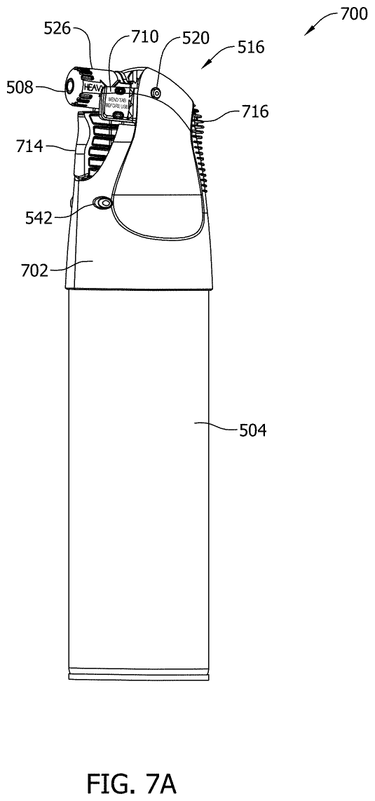

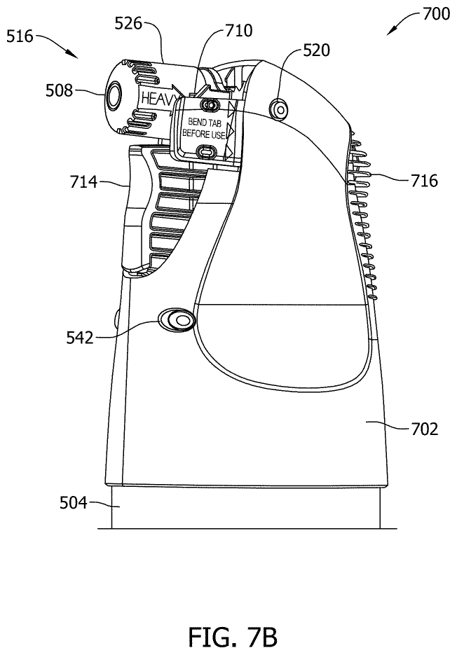

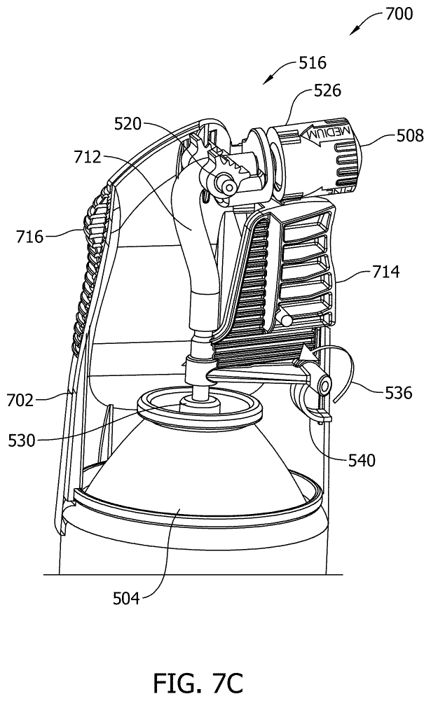

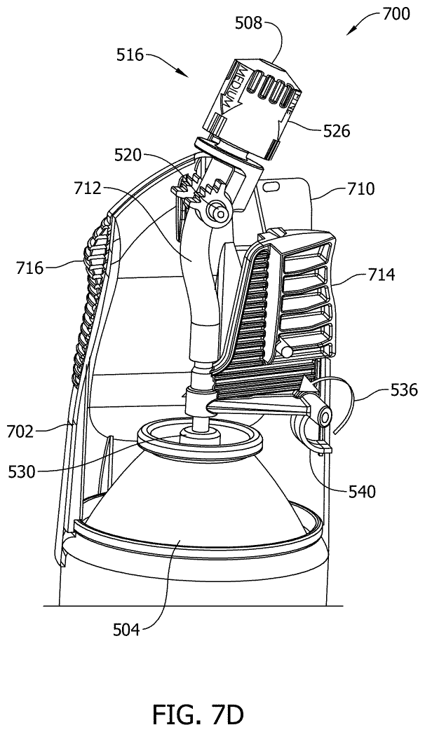

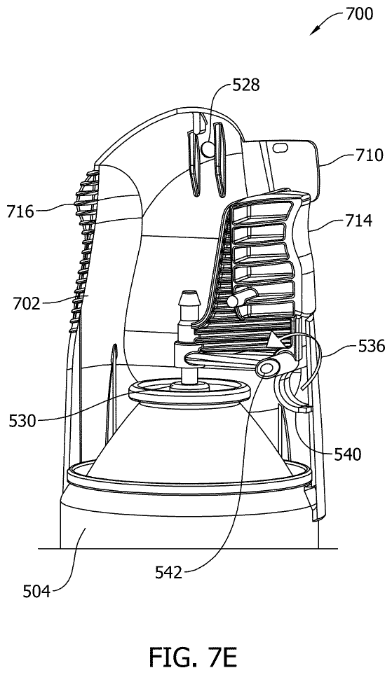

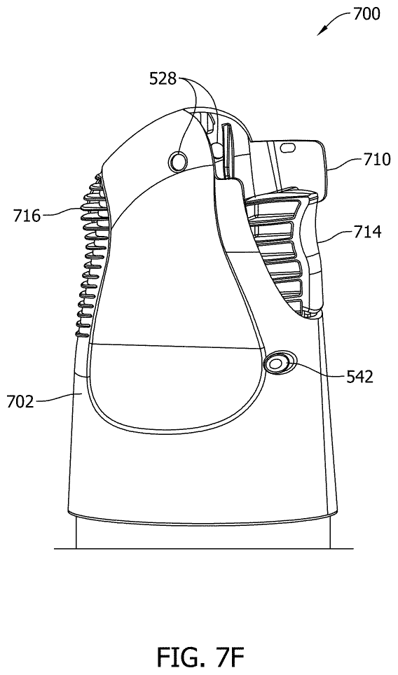

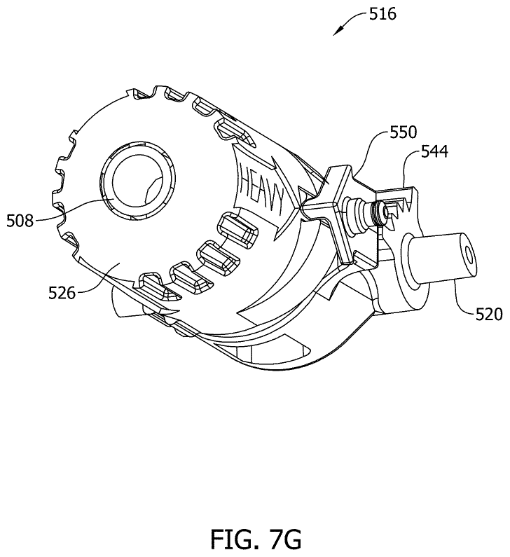

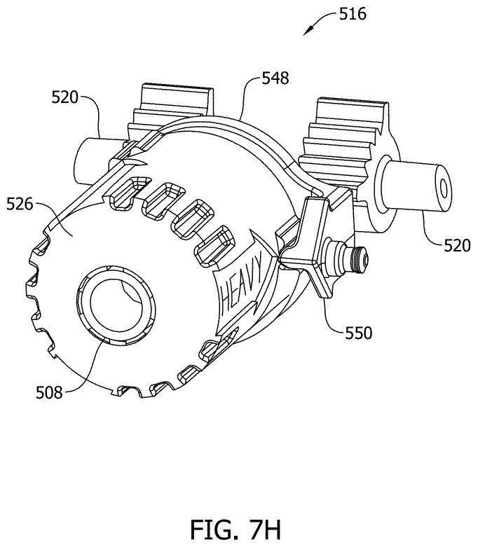

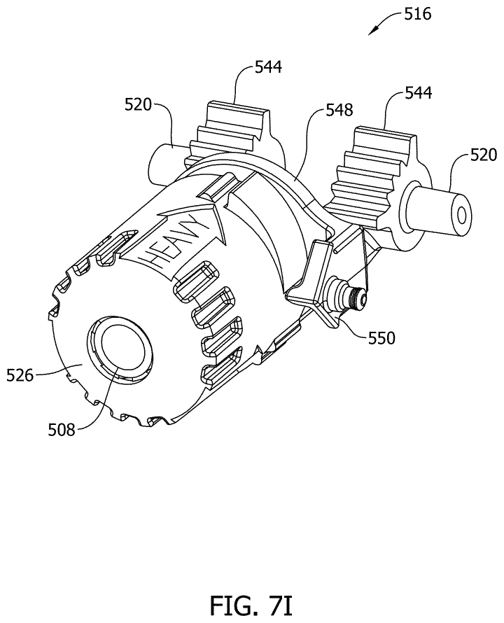

Turning now to the figures, FIG. 1A shows a front view of a first texture material dispensing system 100 while FIG. 1B shows a perspective view of the system 100. FIG. 2A and FIG. 2B show perspective and cross-sectional views of a second exemplary embodiment of a texture material dispensing system 200. FIG. 3A and FIG. 3B show perspective and cross-sectional views of a third exemplary embodiment of a texture material dispensing system 300. FIG. 4 shows a cross-sectional view of an exemplary embodiment of a container assembly 400. FIG. 5A FIG. 5B, FIG. 5C, FIG. 5D, FIG. 5E, FIG. 5F, FIG. 5G, FIG. 5H, FIG. 5I, FIG. 5J, and FIG. 5K show a variety of views of a fourth embodiment of a texture dispensing system 500. FIG. 6A, FIG. 6B, FIG. 6C, FIG. 6D, FIG. 6E, FIG. 6F, FIG. 6G, FIG. 6H, and FIG. 6I show a variety of views of a fifth embodiment of a texture dispensing system 600. FIG. 7A, FIG. 7B, FIG. 7C, FIG. 7D, FIG. 7E, FIG. 7F, FIG. 7G, FIG. 7H, and FIG. 7I show a variety of views of a sixth embodiment of a texture dispensing system 700.

Referring now to FIG. 1A and FIG. 1B, a texture material dispensing system 100 including an actuator housing 102, an actuator assembly 118, and an outlet assembly 116 are shown. The outlet assembly 116 includes an orifice 108 that delivers texture material onto a target surface. The target surface may be a surface selected from the group consisting of a horizontal surface, a vertical surface, an angled surface, and combinations thereof. The target surface may be a ceiling, a wall, or a floor. The texture may be selected from a group consisting of a knockdown texture, an orange peel texture, a popcorn texture, and combinations thereof. The actuator assembly 118 includes an actuator 110 and a trigger 114. The outlet assembly 116 snaps onto the actuator assembly 118. The actuator housing 102 has a snap feature which allows for the trigger 114 to be rotatably coupled or pivotably attached to the actuator housing 102. This is accomplished via trigger posts 120 extending outward from the trigger 114, which allows the trigger 114 to be snapped into the actuator housing 102 and rotate about the actuator housing 102. Depression of the trigger 114 causes the actuator 110 to engage a valve assembly (not shown) to alter the valve assembly from a closed configuration to an open configuration. A tube 112 is located inside actuator 110 that when the trigger is engaged, texture material is delivered through it out of the outlet assembly 116 onto a surface. The trigger 114 includes a spring (not shown) to assist the trigger 114 in returning to a non-use position after depression of the trigger 114.

Referring now to FIG. 2A and FIG. 2B, a texture dispensing system 200 is shown. However, in this embodiment, an outlet assembly 216 includes an outlet switch 218 that moves parallel to the outlet assembly 216. The outlet switch 218 includes a taper 228 that when pressed against the flexible fingers 230 of the actuator 110 and cause the flexible fingers 230 to collapse and pinch the tube inside the actuator 110, thus changing the outlet size of orifice 108. A detent mechanism is provided between the between the outlet switch 218 and the actuator housing 102 to keep the outlet switch 218 in a single position for a specific texture setting for a chosen application.

Referring now to FIG. 3A and FIG. 3B, a texture dispensing system 300 is shown. However, in this embodiment, an outlet assembly 316 includes an outlet switch 318 like the outlet switch 218 of system 200 that moves parallel to the outlet assembly 216. The outlet switch 318 has a series of switch teeth 320 which mesh with cap teeth 322 on the cap 326 surrounding the actuator 110. When the outlet switch 318 is moved, meshing of cap teeth 322 and switch teeth 320 force the cap 326 to rotate. In this embodiment the cap 326 is threaded onto the actuator 110 via a taper 328. When the taper 328 on the cap 326 presses against the flexible fingers 330 of the actuator 110, the flexible fingers 330 collapse and pinch the tube (not shown) inside the actuator 110, thus changing the outlet size of the orifice 108. Similarly, to previous embodiments discussed above, a detent mechanism may be used between the outlet switch 318 and the cap 326 to keep the outlet switch 318 in a single position for a specific texture setting.

Referring now to FIG. 4, an embodiment of a container assembly 400 that may be used with any of the embodiments of texture dispensing systems described above. As the trigger 114 is depressed and pivots about the housing 102 the trigger 114 depresses an interface member 404 connecting the trigger 114 to a valve 406 of a container 402. In other words, depression of the trigger 114 causes the trigger 114 to engage the valve 406 to alter the valve 406 from a closed configuration to an open configuration. The interface member 404 actuates the valve 406 linearly and parallel to the container 402 via a disk component 408. In other words, the pivoting motion of the trigger 114 causes the trigger 114 to engage the disk component 408 linearly and parallel to the container 402 which then actuates the container 402 into an open configuration, thus causing texture material to flow out of the container 402. The trigger 114 snaps to the housing 102. The container 402 stores a texture material and a propellant material.

Referring to FIG. 5A FIG. 5B, FIG. 5C, FIG. 5D, FIG. 5E, FIG. 5F, FIG. 5G, FIG. 5H, FIG. 5I, FIG. 5J, and FIG. 5K, an embodiment of a texture dispensing system 500 is shown. FIG. 5A and FIG. 5B each show a full view of the texture dispensing system 500. An adjustable outlet assembly 516 includes a cap 526, an adjustable orifice 508, and a pair of posts 520 that connect to a housing 502. An actuator trigger 514 is connected to the housing 502 via trigger posts 542 so the actuator trigger 514 is assembled directly into the housing 502 and will pivot directly on the trigger posts 542. The housing 502 is connected to a container 504 that stores a texture material and a propellant material. When the actuator trigger 514 is depressed the texture material and propellant material go through the housing 502 via a tube (not shown) and through the adjustable outlet assembly 516 and out of the adjustable orifice 508 onto a surface. FIG. 5C shows a cross-sectional view of the housing 502. The housing 502 includes an upper housing 510 and a lower housing 512 that are coupled together via a plurality of snap features 522 and locating posts 524. The opening 528 is where a post 520 of the adjustable outlet assembly 516 is connected to the upper housing 510.

As shown in FIG. 5D, a flexible tube (not shown) attaches the actuator trigger 514 to the adjustable outlet assembly 516. The actuator trigger 514 is depressed and the actuator trigger 514 actuates a valve 530 of the container 504. Once the valve 530 is open, texture material flows from inside the container 504, through the valve 530, through the actuator trigger 514, through the flexible tube (not shown), through the adjustable outlet assembly 516, and finally out the adjustable orifice 508 onto a surface. The housing 502 is connected to the container 504 via a plurality of container snaps 532.

As shown in FIG. 5E and FIG. 5F, the actuator trigger 514 pivots 536 about the housing 502 such that the valve 530 on the container 504 is actuated. A spring feature 540 is molded into the actuator trigger 514 to assist the actuator trigger 514 in returning to its original position after it being depressed. The spring feature removes any unwanted movement when transporting or shaking the container 504 during use. A prevention feature is included in the actuator trigger 514 that prevents the actuator trigger 514 from pivoting in the opposite direction and out of the housing 502. The actuator trigger 514 pivots 536 about the trigger posts 542.

As shown in FIG. 5G and FIG. 5H, the adjustable outlet assembly 516 pivots in the housing 502 which allows it to be pointed at multiple angles. The adjustable outlet assembly 516 can pivot fully vertically in reference to the axis of the container 504 and fully horizontally in reference to the axis of the container 504. A detent mechanism 544 keeps the adjustable outlet assembly 516 at a desired angle in increments. The detent mechanism allows a user to spray texture material onto a surface at any angle without moving the container 504. A flexible tube (not shown) connected to the adjustable outlet assembly 516 and allows the adjustable outlet assembly 516 to be used at any angle without impediment of the flow of texture out of the adjustable orifice 508. As shown in FIG. 5I, the cap 526 is threaded onto the adjustable orifice 508. When the cap is threaded clockwise, the cap 526 interferes with the adjustable orifice 508 which causes deformable fingers 552 of the adjustable outlet assembly 516 to squeeze the adjustable orifice 508, which is an outlet tube. This clockwise threading function varies the size of the texture material leaving the system 500 onto a surface. Detent features 546 between the adjustable outlet assembly 516 and the cap 526 allow discrete locations to be chosen by a user to find desired settings and provide uniformity of a desired texture size by rotating the cap 526. In addition, a user has the ability to adjust to any position in between the discrete detents. As shown in FIG. 5J and FIG. 5K, an indicator arrow 550 shows which discrete texture position is selected. The indicator arrow 550 indicates the texture setting (HEAVY) and acts as a stop preventing the cap 526 from being removed from the adjustable outlet assembly 516. A backstop 548 is included in the adjustable outlet assembly 516 that is connected to the indicator arrow 550. The backstop 548 prevents overtightening of the cap 526 when selecting a texture size. Together the backstop 548 and the indicator arrow 550 act as a one-way spring, lifting over the cap 526 when assembled and preventing the cap 526 from being unscrewed from the adjustable outlet assembly 516.

Referring to FIG. 6A FIG. 6B, FIG. 6C, FIG. 6D, FIG. 6E, FIG. 6F, FIG. 6G, FIG. 6H, and FIG. 6I, an embodiment of a texture dispensing system 600 is shown. FIG. 6A and FIG. 6B show full views of the system 600. Texture dispensing system 600 is similar to the system 500. However, the texture dispensing system 600 includes an actuator trigger 614 having a breakaway tab 610. The breakaway tab 610 protrudes from the top portion of the actuator trigger 614 and is used to prevent actuation of the trigger. Additionally, FIG. 6C and FIG. 6D show cross-sectional views of the texture material dispensing system 600 where a flexible tube 612 is connected to the adjustable outlet assembly 516, which allows the adjustable outlet assembly 516 to be used at any angle without impediment of the flow of texture out of the adjustable orifice 508. The flexible tube 612 is further connected to the actuator trigger 614 so texture material is dispensed through the tube 612 when the actuator trigger 614 is depressed and the valve 530 of the container 504 is opened. The flexible tubing 612 helps prevent sharp bends or corners in the flow path of the texture material, which are unavoidable in known molded plastic actuators, as well as allowing the user to spray onto multiple surfaces. The flexible tubing 612 allows flexibility but also functions in delivering texture onto a surface in an anti-clogging manner. FIG. 6C shows the system 600 where the texture is dispensed orthogonal to the container 504. In FIG. 6D, the texture is dispensed approximately parallel to the container 504. FIG. 6E shows a cross-sectional view of the system 600 without the flexible tubing 612 while FIG. 6F shows the system 600 without the outlet assembly 516 or container 504. FIG. 6G, FIG. 6H, and FIG. 6I are views of the outlet assembly 516 used in the system 600.

Referring to FIG. 7A FIG. 7B, FIG. 7C, FIG. 7D, FIG. 7E, FIG. 7F, FIG. 7G, FIG. 7H, and FIG. 7I, an embodiment of a texture dispensing system 700 is shown. FIG. 7A and FIG. 7B show full views of the system 700. Texture dispensing system 700 is similar to system 500 and system 600. However, the texture dispensing system 700 includes a monolithic housing 702 having a breakaway tab 710. The breakaway tab 710 protrudes from the monolithic housing and is used to prevent actuation of the actuator trigger 714 and movement of the adjustable outlet assembly 516. Additionally, texture dispensing system 700 includes an ergonomic grip portion 716 that allows a user to better grip the texture dispensing system 700. Additionally, FIG. 7C and FIG. 7D show cross-sectional views of the texture material dispensing system 700 where a flexible tube 712 is connected to the adjustable outlet assembly 516, which allows the adjustable outlet assembly 516 to be used at any angle without impediment of the flow of texture out of the adjustable orifice 508. The flexible tube 712 is further connected to the actuator trigger 714 so texture material is dispensed through the tube 712 when the actuator trigger 714 is depressed and the valve 530 of the container 504 is opened. The flexible tubing 712 helps prevent sharp bends or corners in the flow path of the texture material, which are unavoidable in known molded plastic actuators, as well as allowing the user to spray onto multiple surfaces. The flexible tubing 712 allows flexibility but also functions in delivering texture onto a surface in an anti-clogging manner. FIG. 7C shows the system 700 where the texture is dispensed orthogonal to the container 504. In FIG. 7D, the texture is dispensed approximately parallel to the container 504. FIG. 7E shows a cross-sectional view of the system 700 without the flexible tubing 712 while FIG. 7F shows the system 700 without the outlet assembly 516 or container 504. FIG. 7G, FIG. 7H, and FIG. 7I are views of the outlet assembly 516 used in the system 700.

Based upon the above discussion and illustrations, those skilled in the art will readily recognize that various modifications and changes may be made to the various embodiments without strictly following the exemplary embodiments and applications illustrated and described herein. For example, the trigger, adjustable orifice, and actuator may be utilized for a multitude of different types of dispensers and dispensing approaches, for a variety of materials. Further, the embodiments noted herein may be combined, and further embodiments may be separated. Other shapes, such as an oblong shape, and other forms of rotation such as a truncated arc, may be utilized as well, with locking approaches as noted herein. Such modifications do not depart from the scope of various aspects of the invention, including aspects set forth in the claims.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A texture material dispensing system comprising:
a container assembly comprising a container and a valve assembly;
an actuator assembly comprising a trigger actuator pivotably attached to an actuator housing; and
an outlet assembly comprising a flexible tube fluidically connected to the trigger actuator and an adjustable outlet opening comprising an orifice, wherein the adjustable outlet opening is adjustable between a position that is aligned substantially parallel to a container assembly axis and a position that is aligned substantially non-parallel to a container assembly axis.

2. The texture material dispensing system of claim 1, wherein the outlet assembly snaps onto the actuator assembly; and wherein the actuator assembly snaps onto the container assembly.

3. The texture material dispensing system of claim 1, wherein depression of the trigger actuator causes the trigger actuator to engage the valve assembly to alter the valve assembly from a closed configuration to an open configuration.

4. The texture material dispensing system of claim 1, wherein the trigger actuator comprises a spring to assist the trigger actuator in returning to a non-use position after depression of the trigger actuator.

5. The texture material dispensing system of claim 1, wherein the adjustable outlet opening is a pivotable outlet opening that pivots around an outlet pivot within the actuator housing.

6. The texture material dispensing system of claim 5, wherein the outlet pivot comprises a detent portion to hold the pivotable outlet opening at a desired angle.

7. The texture material dispensing system of claim 6, wherein the detent portion comprises at least one location that clicks when the pivotable outlet opening is pivoted into the at least one location.

8. The texture material dispensing system of claim 1, wherein the texture material dispensing system is configured for dispensing an aerosol comprising a texture material.

9. The texture material dispensing system of claim 1, wherein the orifice is an adjustable orifice that controls a flow rate of dispensed texture material.

10. The texture material dispensing system of claim 9, wherein the adjustable orifice comprises a threaded outlet, a screw cap and at least one deformable finger.

11. The texture material dispensing system of claim 10, wherein the flow rate of dispensed texture material is proportional to the tightness of the screw cap on the threaded outlet.

12. The texture material dispensing system of claim 10, wherein a cross-sectional area of the adjustable orifice is proportional to the tightness of the screw cap on the threaded outlet.

13. The texture material dispensing system of claim 10, wherein the adjustable orifice comprises a backstop to prevent overtightening of the screw cap.

14. The texture material dispensing system of claim 10, wherein the adjustable orifice comprises a stop to prevent removal of the screw cap from the adjustable orifice.

15. The texture material dispensing system of claim 10, wherein the stop comprises an indicator of the flow rate of the texture material.

16. The texture material dispensing system of claim 1, wherein the texture material dispensing system comprises a moveable lock configured to prevent actuation of the trigger and/or movement of the adjustable outlet opening.

17. A method of using a texture material dispensing system comprising:
a container assembly comprising a container and a valve assembly;
an actuator assembly comprising a trigger actuator pivotably attached to an actuator housing; and
an outlet assembly comprising a flexible tube fluidically connected to the trigger actuator and an adjustable outlet opening comprising an orifice, wherein the adjustable outlet opening is adjustable between a position that is aligned substantially parallel to a container assembly axis and a position that is aligned substantially non-parallel to a container assembly axis;
the method comprising using the texture material dispensing system for dispensing a texture material onto a target surface.

18. The method of claim 17, wherein the target surface is a surface selected from the group consisting of a horizontal surface, a vertical surface, an angled surface, and combinations thereof.

19. The method of claim 17, wherein the target surface is a ceiling, a wall, or a floor.

20. The method of claim 17, wherein the method dispenses onto the target surface a texture selected from the group consisting of a knockdown texture, an orange peel texture, a popcorn texture, and combinations thereof.
